(19) United States
(12) Patent Application Publication
(10) Pub. No.: US 2002/0108302 A1
(43) Pub. Date: Aug. 15, 2002

(54) Decorative flower holder

(76) Inventor: Christian T. Gregory, La Crescenta, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/027,904

(22) Filed: Oct. 24, 2001

Related U.S. Application Data
(60) Provisional application No. 60/242,670, filed on Oct. 24, 2000.

(51) Int. Cl. A01G 5/00; A47G 7/00

(52) U.S. Cl. 47/41.15

(57) ABSTRACT

A decorative flower holder including a cylindrical section with one closed end and a resilient cap that fits over the open end of the cylinder. A small hole in the cap allows the placement of a flower stem through it. In addition, this decorative flower holder includes a means by which the flower vial assembly can be suspended or supported so that the item in the vial can be displayed in an ornamental fashion. With this supporting means, flowers or other plant material can be displayed in many different situations such as on a Christmas tree as an ornament, on a window, on a car rear view mirror, etc.

### CROSS-REFERENCE TO RELATED APPLICATION

This application claims the benefit of U.S. Provisional Application No. 60/242,670 filed on Oct. 24, 2000 which is hereby incorporated by reference as if set forth in full herein

### BACKGROUND OF THE INVENTION

This invention relates to holders for fresh cut flowers and other plant material. In particular, it is in the field of vases, flower holders and the like. In conjunction with a support or suspension mechanism, this invention allows the display of said plant material in unique, interesting and convenient locations, such as on a Christmas tree functioning as an ornament.

A plastic flower vial and some variations have been patented including one that has a tapered arrow-like protrusion on the end of the cylinder to facilitate the insertion of the vial into foam often used in flower arrangements. Other inventions include a vase found in a magazine called “Solutions”. This product was called “The Bud VaseTM” and was referenced by a part number 62158. The phone number for ordering from the catalog is 1-800-342-9988. In addition to the above, there are numerous patents for vases. By way of example, the following is a list of patent titles and their corresponding numbers.

Flower Displaying Ornament, U.S. No. D253,095

Support Structure for Small Floral Arrangement, U.S. Pat. No. 4,418,496

Ornamental Fixture for Suspending Potted Plants, U.S. Pat. No. 4,524,542

Planter Tree for Floor, Wall or Ceiling Mounting, U.S. Pat. No. 4,389,813

Flower Holder Jewelry Article, U.S. Pat. No. 4,712,389

Vial Device, U.S. Pat. No. 3,768,685

Circular Plant Mobile, U.S. Pat. No. 4,691,473

Bud Vase and Attachment Bracket, U.S. Pat. No. 4,880,133

Receptacle Hanger, U.S. Pat. No. 4,825,590

Interlocking Plant Mobile, U.S. Pat. No. 5,290,001

Combination Greeting Card, Ornament and Seed Germination Box, U.S. Pat. No. 4,418,497

### SUMMARY OF THE INVENTION

The Decorative Flower Holder's features allow a convenient means to cost-effectively display flowers in unique places while keeping them fresh for long periods of time.

One object of this invention is to provide a means to keep the displayed plant material hydrated and attractive for long periods of time.

A second object of this invention is to provide a support mechanism that facilitates convenient viewing of the plant material by an observer.

A third object of this invention is to allow the item to be displayed in a variety of interesting locations. This is largely related to the fact that the Decorative Flower Holder can be designed to be very small and light in weight.

A fourth object of this invention is to provide a Decorative Flower Holder that can be manufactured and sold at a low cost. In this way, the consumer will have the option of utilizing large numbers of Decorative Flower Holders for projects such as trimming a Christmas tree, for example.

These and other objects are achieved in accordance with this invention by a unique design concept of a flower display holder. One advantage of this invention is that it provides a completely new way to display flowers and other plant material. The small size and light weight of a Decorative Flower Holder assembly, in conjunction with its attachment features, allows a convenient means to display flowers as ornaments in unique places and in a cost-effective way.

In a preferred embodiment, there is a means by which a flower vial assembly can be suspended or supported so that an item in the vial can be displayed in an ornamental fashion. With this supporting means, flowers or other plant material can be displayed in many different situations such as on a Christmas tree as an ornament, by way of example. Following are some reasons that this preferred form is advantageous:

(1) manufacturers of existing flower vials could easily modify their tooling to start fabrication of Decorative Flower Holders very quickly;

(2) Decorative Flower Holders made from plastics would be very inexpensive; and

(3) easy and low cost manufacturing would allow more money to be spent on marketing so that the product could get widespread recognition and acceptance from consumers.

This invention has many other advantages, and other objectives, which may be more clearly apparent from consideration of the various forms in which it may be embodied. Certain versions of such forms are shown in the drawings accompanying and forming a part of the present specification. These forms will now be described in detail for the purpose of illustrating the general principles of the invention; but it is understood that such detailed description is not to be taken in a limiting sense.

### BRIEF DESCRIPTION OF THE DRAWINGS

FIG. 1 is a isometric view of a water vial similar to those currently used by florists, the resilient cap shown removed;

FIG. 1a is a cross section through a water vial assembly, shown with a flower inserted;

FIG. 2 is an isometric view of another type of existing water vial that is designed to be inserted into foam for flower arrangements, the resilient cap shown installed;

FIG. 3 is an isometric view of one design concept for the preferred embodiment of the invention, the resilient cap shown installed;

FIG. 4 shows an isometric view of a second embodiment of the invention consisting of an existing water vial inserted into a hollow cylindrical piece with means for attachment;

FIG. 5 demonstrates the purpose of the design feature that allows each decorative flower holder to be positioned at different angular attitudes;

FIGS. 6a, 6b, and 6c depict side views of three decorative flower holders of the preferred embodiment showing how to use multiple holes to adjust the angular attitude of each holder;

FIGS. 7a, 7b, and 7c depict side views of three decorative flower holders of a second embodiment showing their angular attitude adjustment by use of different length water vials;

FIGS. 8a, 8b and 8c are side views of decorative flower holders of an embodiment where support is from below, showing different ways to adjust the angular attitude of each holder;

FIG. 9 is a cross section through a decorative flower holder showing its use without a resilient cap;

FIG. 10 is a side view of the invention showing its use in conjunction with a hood, both for protective and decorative purposes;

FIG. 11 is a cross section through a version of the preferred embodiment that contains a light receptacle;

FIG. 12 is an isometric view of another embodiment in which the holder for the flower or water vial is spherical like a traditional Christmas tree ornament;

FIG. 13a is a cross section through another variation of the preferred embodiment that has two attachment features and an expanded area on the closed end of the vial to act as a counterbalance for the flower;

FIG. 13b is the embodiment shown in FIG. 13 with a flat on the closed end of the vial so that it can stand vertically on a flat surface;

FIG. 14 shows two decorative flower holders in which one is hanging off the bottom of the other one;

FIGS. 15a and 15b shows a concept in which a water vial has multiple features that interconnect with other vials of the same design,

FIG. 16a shows how the interconnecting features can be staggered so that the flowers are roughly vertically aligned when the cluster of vials are hung;

FIG. 16b shows how the interconnecting features allows the vials to be free standing;

FIG. 17a shows the preferred embodiment with a weight on the inside at the closed end of the vial as a counterbalance for the flower;

FIG. 17b shows the preferred embodiment with a feature to allow insertion of a weight below the closed end of the vial as a counterbalance for the flower;

FIG. 17c shows the preferred embodiment with the closed end wall being thicker to act as a counterbalance for the flower;

FIG. 18a shows a variation on the second embodiment with a weight inserted into the end of the hollow member to act as a counterbalance for the vial and flower assembly;

FIG. 18b shows another variation on the second embodiment in which the end of the hollow member is closed and has a thick wall to act as a counterbalance for the vial and flower assembly;

FIG. 19 shows another variation of the decorative flower holder in which it rests directly on a Christmas tree branch and is held in place by a feature that attaches to the branch;

FIG. 20a shows a variation on the second embodiment in which the hollow member is very short;

FIG. 20b shows a variation on the second embodiment in which the hollow member is replaced by a string or wire; and

FIG. 20c shows a variation on the second embodiment in which the hollow member is replaced by a spirally shaped member.

### DETAILED DESCRIPTION OF THE INVENTION

Referring to the drawings, FIG. 1 shows a water vial assembly 2 similar to those currently used by florists. This consists of a container 4 which is basically cylindrical in shape. This container 4 is closed on one end and performs the function of holding fluid to keep a flower hydrated and in existing water vial designs is usually made of plastic. A resilient cap 6 with a hole 8 in the center fits over the open end of the container 4 by stretching it over a raised lip 10. When seated over the open end of the container 4, an internal rib 12 inside the resilient cap 6 registers below the raised lip 10, forming both a fluid-tight seal and a means of retaining the resilient cap 6 in place, see FIG. 1a. The resilient cap 6 also forms a water-tight seal between the hole 8 and a flower 14 inserted into the container 4 and provides a means to keep the flower 14 centered in the open end of the container 4, also as seen in FIG. 1a. Note that the resilient cap 6 is shown removed in FIG. 1. Also note that the definition of the word “container” is used in this entire body of writing to describe a vessel that can hold fluid and that has an opening through which fluid and flowers can be inserted.

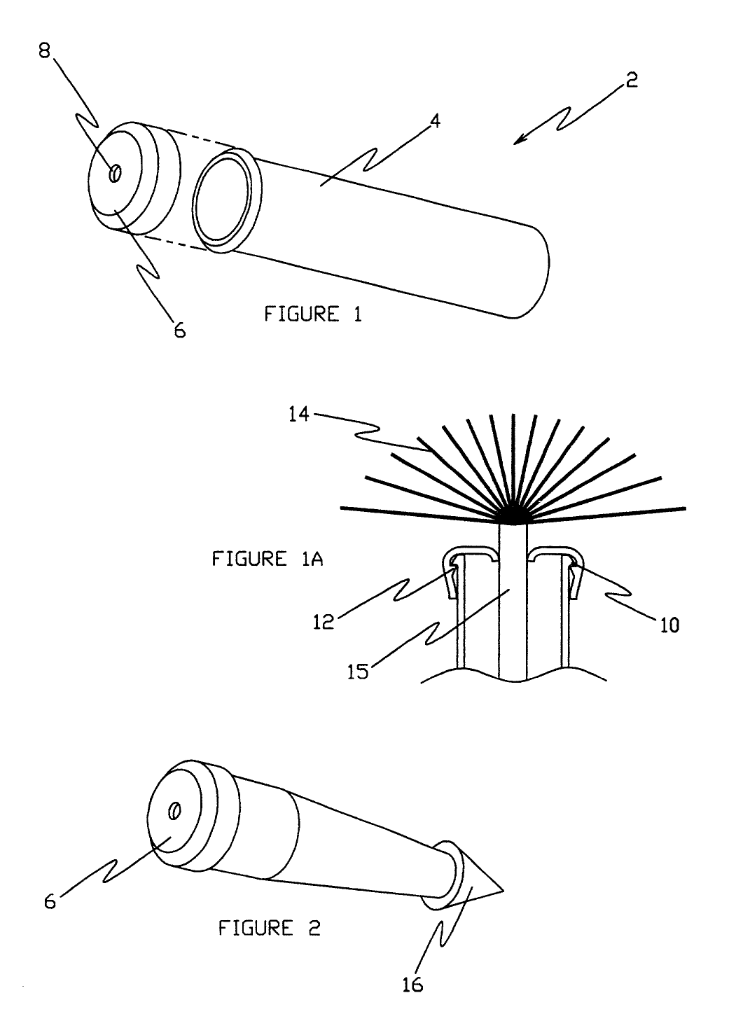

FIG. 2 is a representation of another type of existing water vial design. This vial concept also has the resilient cap 6, but attached to the closed end of this container 4 is an arrow-like protrusion 16. This arrow-like protrusion 16 facilitates the insertion of the water vial into foam often used in flower arrangements.

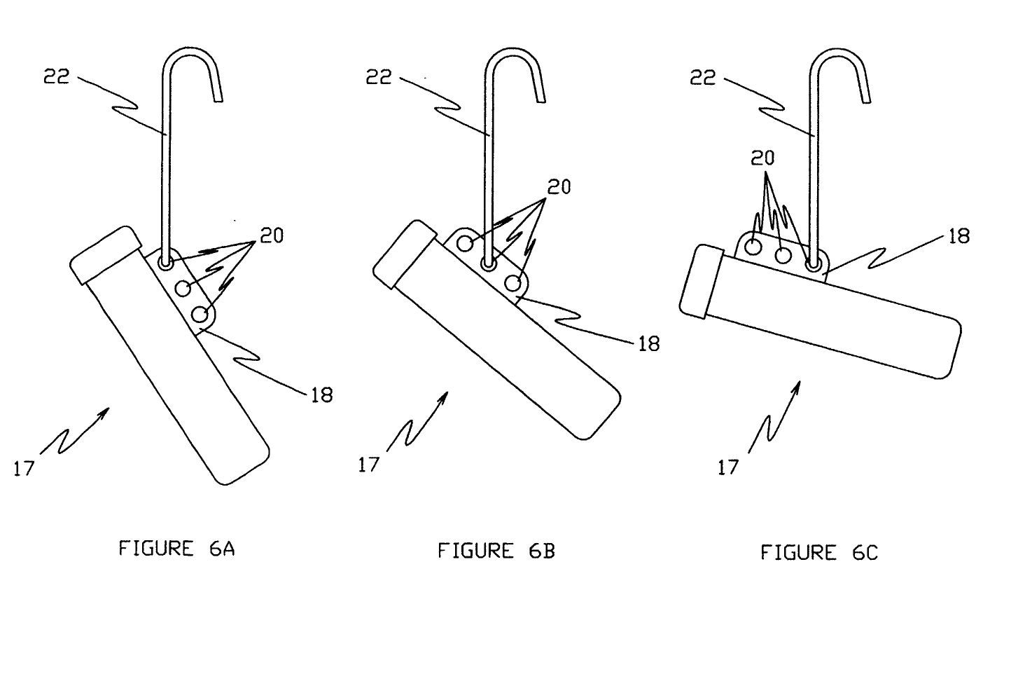

FIG. 3 is an isometric representation of a preferred embodiment 17 of the invention. The preferred embodiment includes a container 4 and a resilient cap 6. The resilient cap 6 having a hole 8 in it to allow the insertion of, and to form a water-tight seal against, the flower 14. The container 4 having a raised lip 10 over which the resilient cap 6 fits. The resilient cap 6 having an internal rib 12 which registers against the raised lip 10. In addition to these features, the invention also includes a means by which to hang or support the decorative flower holder. On the version of the preferred embodiment 17 shown in FIG. 3, this is represented as a tab 18. This tab 18 is attached to the container 4 and includes an attachment feature on which a support mechanism 22 can attach. See FIG. 6. Note that the support mechanism 22 could be functionally replaced by a string, chain, wire, cable, strap, magnet, etc., or anything capable of supporting the weight of the preferred embodiment 17 or other embodiment, see FIG. 4, by suspension or any other means of support. In the version shown in FIG. 3 the attachment feature 20 is represented as a hole in the tab 18, however, the attachment feature 20 could be any interface that allows the support mechanism 22, to suspend or support the weight of the decorative flower holder.

FIG. 4 is an isometric view of a second embodiment 24 of the invention. This consists of a hollow member 26 open at least at one end with a means by which it could be suspended or supported. Note that the hollow member 26, although represented as a hollow cylinder with the attachment feature 20, as shown in FIG. 4, could be anything that holds the water vial assembly 2 and provides means to attach a support mechanism 22, as described above. The representation of this concept in FIG. 4 has the tab 18 with the attachment feature 20. In this design, however, these features are attached to the hollow member 26, as opposed to, the container 4. The inside dimensions of the hollow member 26 are sized to allow the insertion of an existing water vial assembly 2. The attachment feature 20 shown is positioned offset from the center of gravity of the assembly, allowing the end of the water vial assembly 2 opposite the resilient cap 6 to hang downward at a negative attitude. In this way, the resilient cap 6, which is sized so as to not fit through the hollow member 26, registers on the upward facing end of the hollow member 26, thus preventing the water vial assembly 2 from falling out. Note that the water vial assembly 2 could be prevented from falling out of the hollow member 26 by any number of additional mechanism. For example, the hollow member 26 could be closed off at one end so that the end of the container 4 in the water vial assembly 2 would rest on the closed end of the hollow member 26.

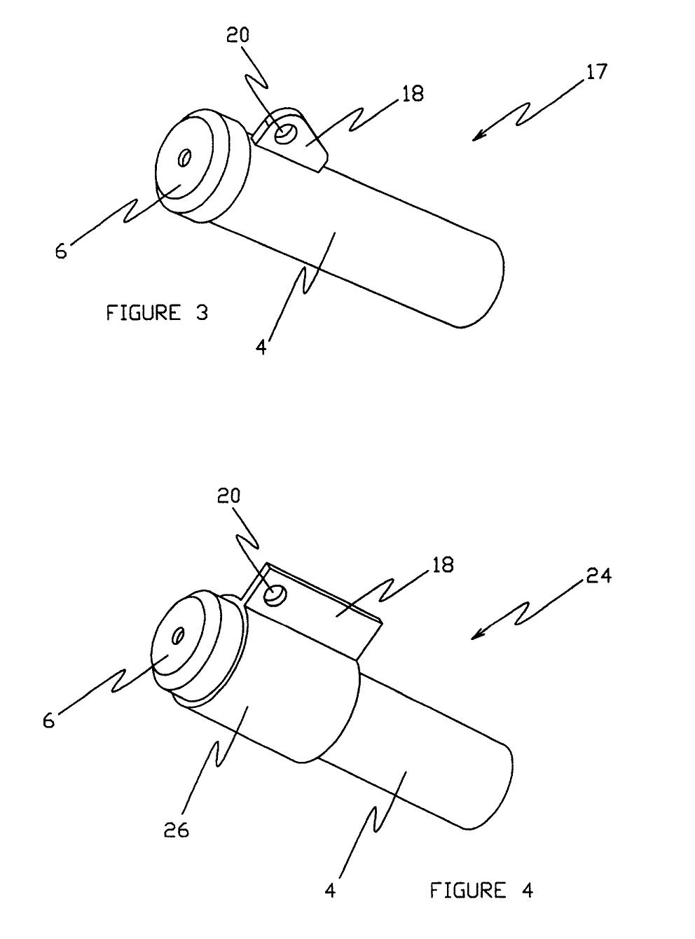

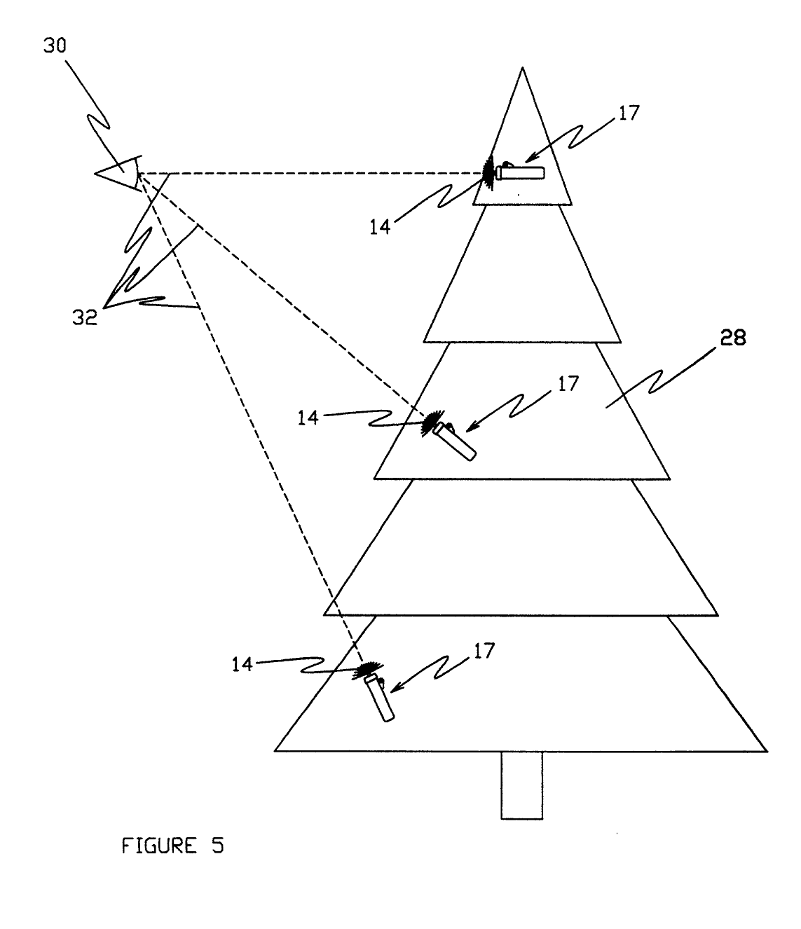

FIG. 5 shows how the display of the invention at different angular attitudes can be beneficial in terms of ease of visibility to an observer. In FIG. 5 a Christmas tree 28 is represented with three samples of the preferred embodiment 17 shown hanging at different levels. Also drawn is a representation an observer's eye 30 and sight lines 32 between the observer's eye 30 and the flowers 14 being displayed. Flowers 14 at different heights on the Christmas tree 28 are more easily seen when their angular attitude is close to the sight line 32 angle of an observer.

FIGS. 6a, 6b and 6c each show the preferred embodiment 17 with the support mechanism 22 installed. The tab 18 in each figure has multiple attachment feature 20 points. FIGS. 6a, 6b and 6c show how installation of the support mechanism 22 in each of the different holes affects the angle at which the preferred embodiment 17 hangs. In this configuration, the support mechanism 22 is being moved relative to the center of gravity of each assembly.

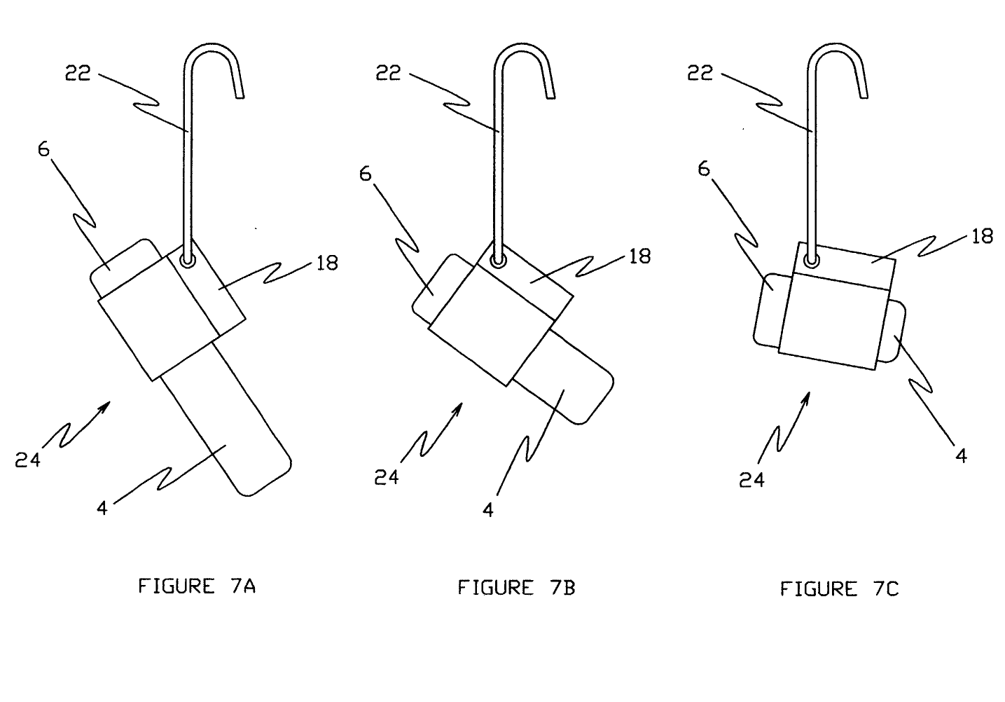

FIGS. 7a, 7b, and 7c each show the second embodiment 24 with the support mechanism 22 installed. In this case, the angular attitude of the second embodiments 24 are adjusted by using different length water vial assemblies 2 to move the center of gravity relative to the support mechanism 22. Note that the use of multiple attachment feature 20 points on the hollow member 26 could be used in conjunction with the differing length water vial assemblies 2 to provide even more adjustability.

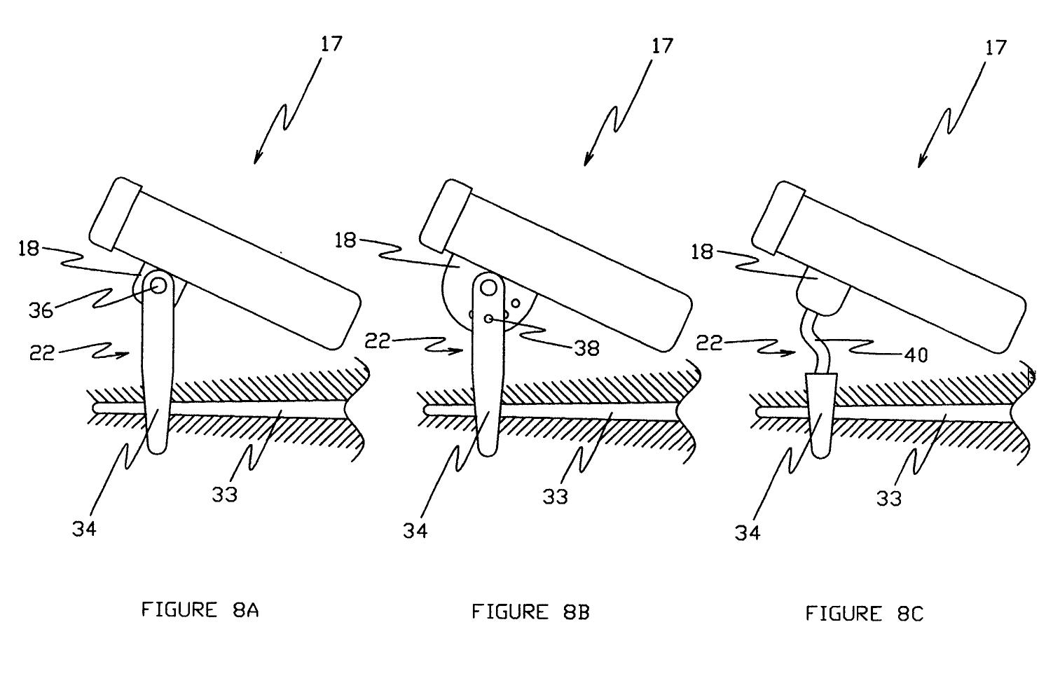

FIGS. 8a, 8b and 8c each show the preferred embodiment 17 being supported from the bottom instead of being suspended from the top. In all three figures the assembly is attached to a Christmas tree branch 33 with different types of support mechanisms 22 that have a clamping feature 34, such as an alligator clip or clothes pin. In FIG. 8a angular adjustment is accomplished with a frictional pivot 36 located between the support mechanism 22 and the tab 18. In FIG. 8b the tab 18 uses a locking pivot 38 with several discreet positions to provide for angular adjustment. FIG. 8c shows a third method for adjusting the angle by using a malleable wire 40 as part of the support mechanism 22 located between the clamping mechanism 34 and the tab 18. These represent three possible ways to both support from the bottom and allow angular adjustment of the preferred embodiment 17 of the decorative flower holder. Note that these support mechanisms could also be used in conjunction with the second embodiment 24.

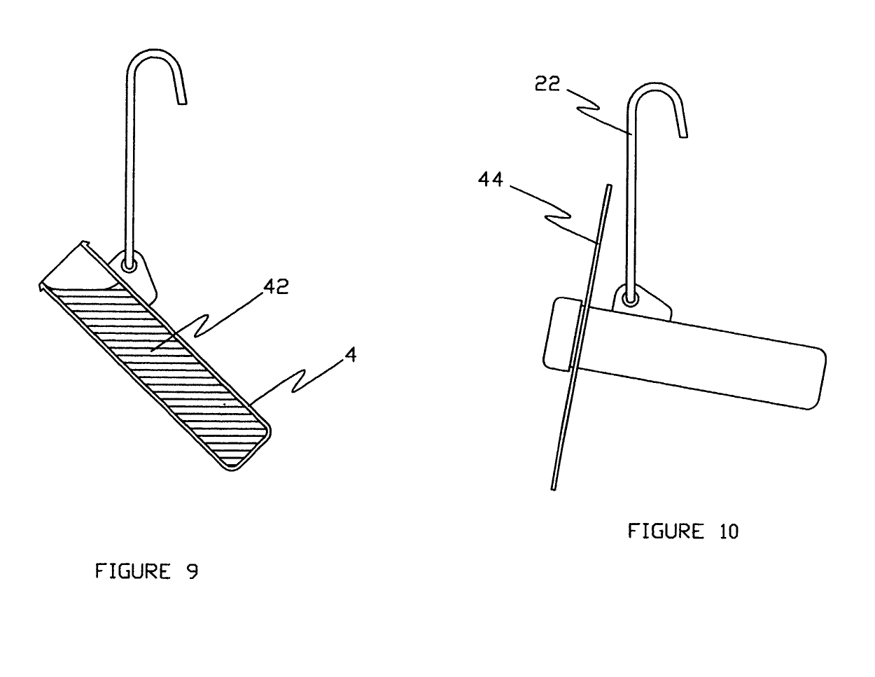

FIG. 9 is a cross section through the preferred embodiment 17 showing its use without a resilient cap 6. The hatching in the figure represents a hydrating fluid 42 and shows that just as long as the angle of the container 4 is large enough relative to the horizontal, that the hydrating fluid 42 will remain inside the container 4 and successfully keep the flower 14 hydrated.

FIG. 10 shows a side view of the preferred embodiment 17 with one version of the support mechanism 22 installed. In addition, there is a hood 44 located behind the flower 14. One of the reasons for having the hood 44 is to provide an aesthetically pleasing backdrop behind the flower 14, such as a reflective surface to show the back side of the flower 14 or colored to compliment the colors in the flower 14. Another purpose is to provide a protective barrier between the flower 14 and things that might damage or discolor the flower 14. As an example, the hood 44 could prevent needles from the Christmas tree 28 from touching the flower 14 if the invention is used as an ornament on the Christmas tree 28. The flowers 14 in prototypes of the invention tested on the Christmas tree 28 without the hood 44 installed turned brown where the needles came in contact with the flowers 14. Hoods 44 could be made in many shapes and sizes, as well as, from a variety of different materials.

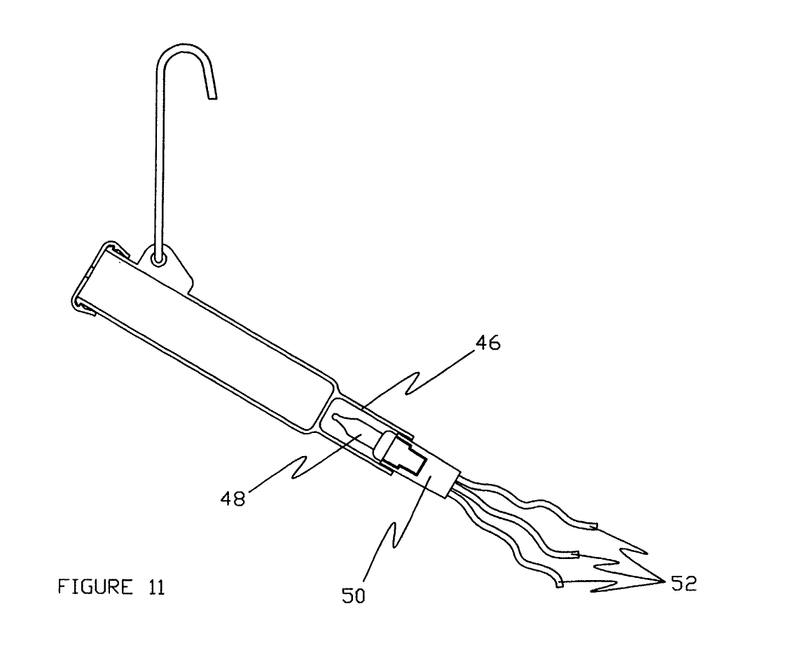

FIG. 11 shows a cross section through the preferred embodiment 17 with a light receptacle 46 attached. The light receptacle 46 could be added to any of the embodiments as a separate piece, or it integrally formed into the invention. What this allows is the insertion of a light bulb 48 into some part of the invention. The representation shown in FIG. 11 shows one light bulb 48 from a string of lights on the Christmas tree 28 inserted into the light receptacle 46 which, in this case, is an integral part of the container 4. One reason for adding the light bulb 48 is for aesthetic purposes. If the container 4 is made from a clear or opaque material, the light bulb 48 will illuminate the container 4 to provide an additional aesthetic feature to the invention. Another reason for adding a light bulb is add warmth to the hydrating fluid 42 in the container 4. Some flowers 14 respond well to the hydrating fluid 42 being warm instead of cold. As a final note, the light receptacle 46 could be designed to be the attachment feature 20 with the support mechanism 22 being the light bulb 48, in conjunction with, the mechanism to which the light bulb 48 attaches. This mechanism possibly being a light socket 50 and wires 52 that provide electricity to the light bulb 48.

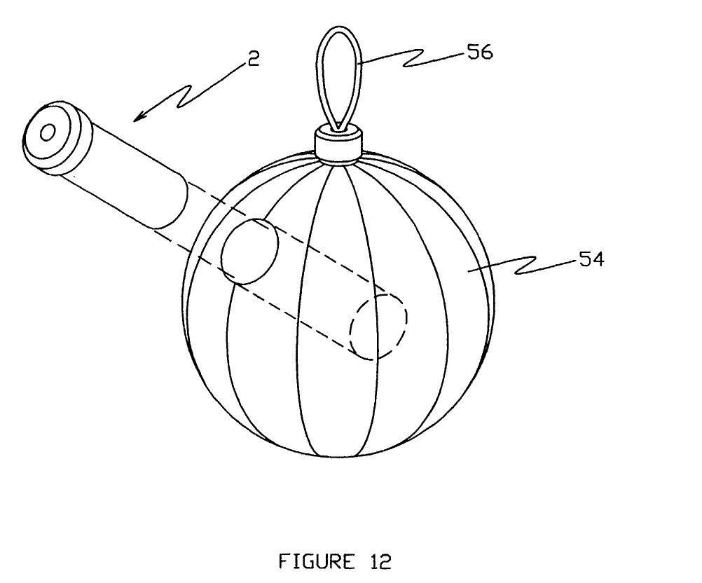

FIG. 12 shows as isometric view of the second embodiment 24 in which the water vial assembly 2 is inserted into a spherical hollow member 54. Note that this configuration could also take the form of the preferred embodiment 17 by simply eliminating the water vial assembly 2 and placing the flower 14 directly into the spherical hollow member 54. This concept would allow the use of traditional looking ornaments on a Christmas Tree 28. Note that it would still be desirable to provide some means of counterbalancing the assembly so that it hangs at a good angular attitude. This could be accomplished by offsetting the ornament hanger 56 relative to the center of the sphere, adding a weight as a counterbalance, or including multiple attachment features 20 as depicted in FIGS. 6a, 6b and 6c.

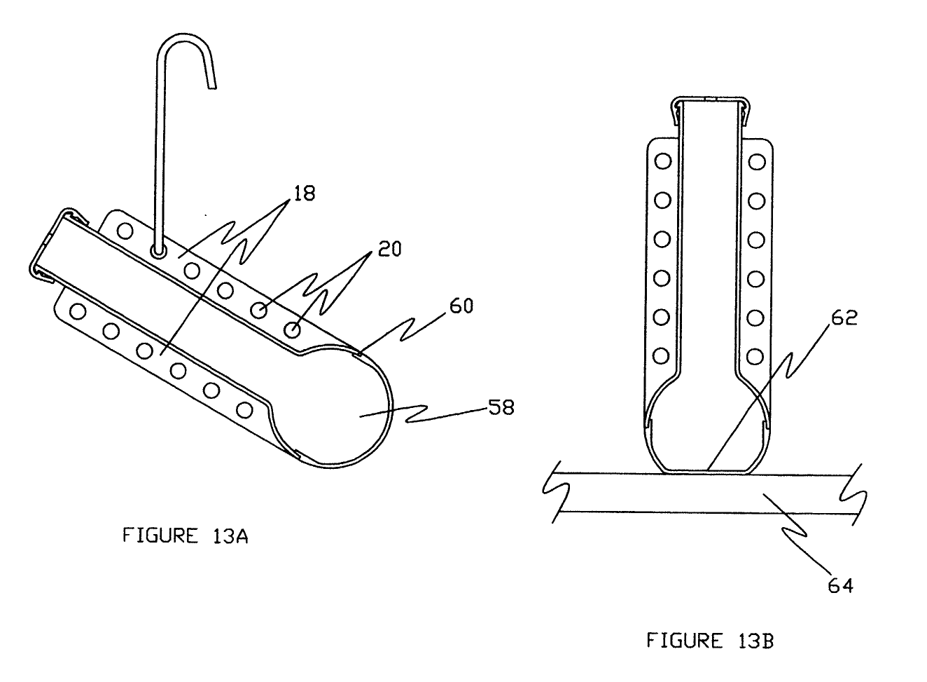

FIG. 13a shows another variation on the preferred embodiment 17 that has other additional features. First, this embodiment has multiple tabs 18 containing one or more attachment features 20. The purposes and benefits of these extra tabs 18 will be discussed in more detail in subsequent figures. Also, the closed end on this container 4 has an expanded end 58 designed to hold additional hydrating fluid 42 near the cut end of the flower stem 15. The location of this additional hydrating fluid 42 acts to counterbalance the flower 14, even as the flower 14 gains weight over time as it draws hydrating fluid 42 up through the flower stem 15. This helps ensure that the flower 14 stays well hydrated over time since a large percentage of the hydrating fluid 42 resides in the expanded end 58 of the container 4. The dimensions on this variation could easily be adjusted to allow the display of any size flower 14, large or small. One final detail represented in the figure is a connection joint 60 on the expanded end 58 which might help during manufacture, depending on the materials and processes chosen. As an example, if the container 4 were made from plastic, it could be injected molded in two pieces and then ultrasonically welded together at the connection joint 60. Similarly, the two pieces of the container 4 could be glued or snapped, or, depending on the manufacturing process, a connection joint 60 might not be required at all.

FIG. 13b shows the identical concept described in the discussion of FIG. 13a. In addition, it also includes a flat spot 62 on the expanded end 58 so that the assembly can be free-standing on a roughly horizontal surface 64.

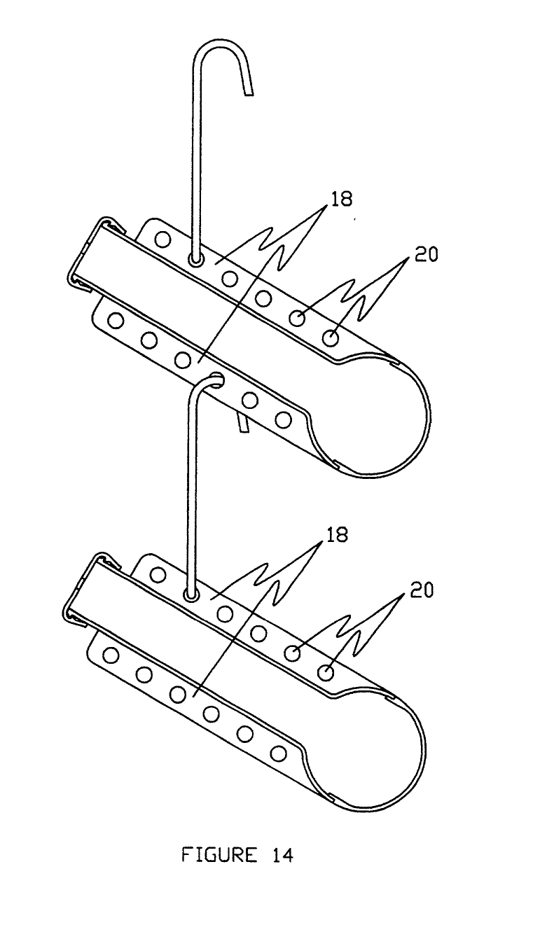

FIG. 14 shows one use of multiple tabs 18 on the variation on the preferred embodiment 17 with an expanded end 58. In this configuration, one decorative flower holder assembly is suspended from a second decorative flower holder. With multiple attachment features 20, the lower decorative flower holder can be used as yet another way to provide counterbalance to the assembly above it. In effect, the lower assembly is simply acting as a moveable weight to adjust the angular attitude of the assembly above. Also, multiple decorative flower holders hanging one from another add another aesthetic display possibility. Note that the expanded end 58 is not required in order for the multiple tabs 18 to be used as described. The variation on the preferred embodiment 17 shown in FIG. 3 could just as easily have multiple tabs 18.

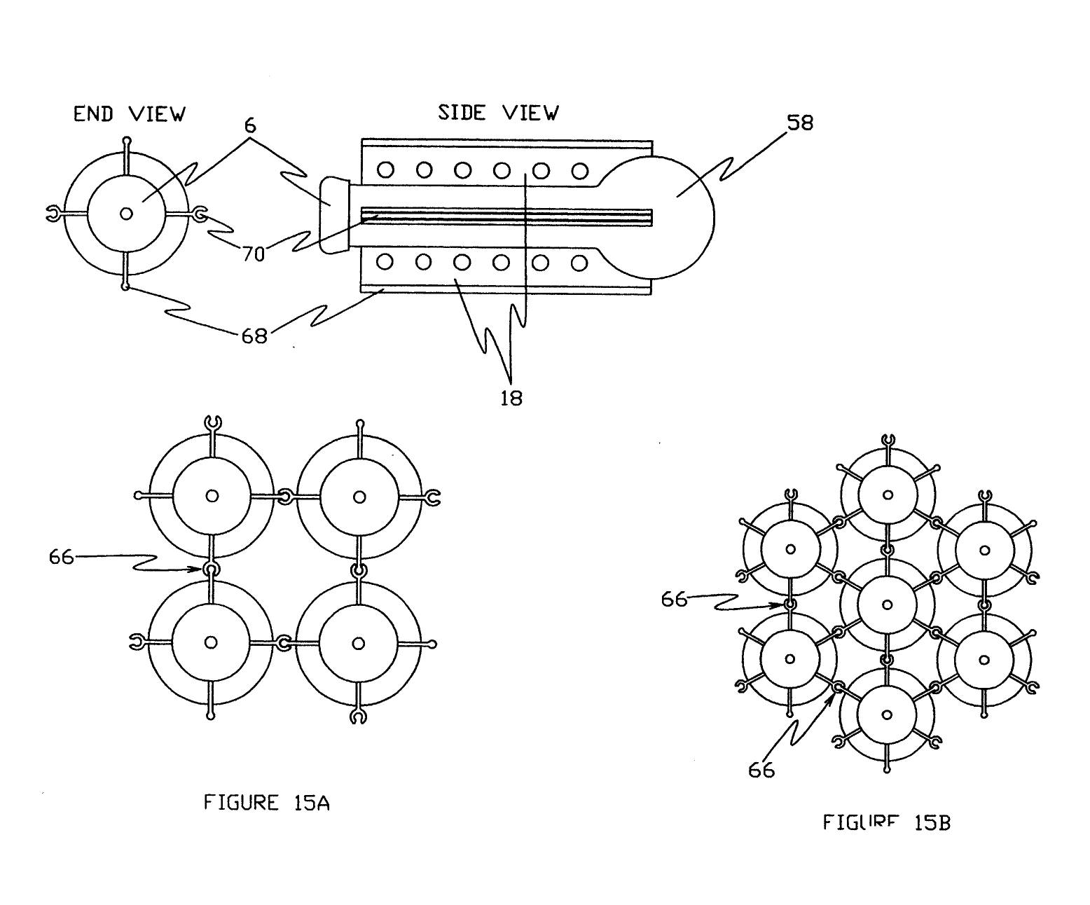

FIG. 15a shows another variation on the preferred embodiment 17 with multiple tabs 18, an expanded end 58, and interconnection features 66. These interconnection features 66 allow multiple decorative flower holders to be attached together in an array. This has several applications that will be described in the discussion of subsequent figures. The interconnection feature 66 shown has a cylindrical member 68 that snaps or slides into a mating elongated socket 70. Note that this is just one concept for an interconnection feature 66 and is being used for illustration purposes. Many other means to provide this attachment also exist.

FIG. 15b shows an array of decorative flower holders, each having six tabs 18, three cylindrical members 68 and three elongated sockets 70. This arrangement allows the assembly of an array having the geometry shown.

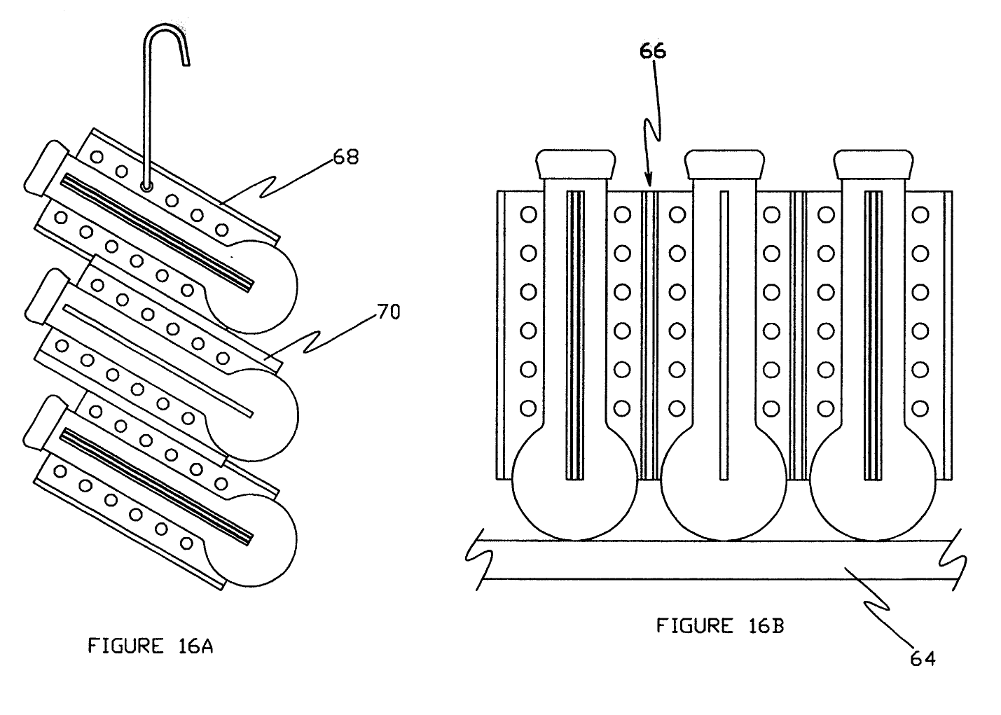

FIG. 16a shows decorative flower holders with interconnection features 66 assembled in a staggered fashion for suspension. Adjusting the relative locations of these flower holders one to another allows the counterbalance for the flowers 14 to be adjusted. Additionally, the interconnection features 66 allow the adjustment of the flowers 14 into a roughly vertical alignment if desired. Entire arrays of decorative flower holders could be arranged and suspended in this fashion.

FIG. 16b shows an array of decorative flower holders held together by interconnection features 66 standing upright on a horizontal surface 64. One possible application for this feature would be to create a free-standing bouquet of flowers. Also, it could be utilized by florists for use during flower arranging as a substitute for traditional vases or flower arranging foam. Additionally, the decorative flower holders could subsequently be disconnected and used as Christmas Tree 28 ornaments or in any of the other ways already described.

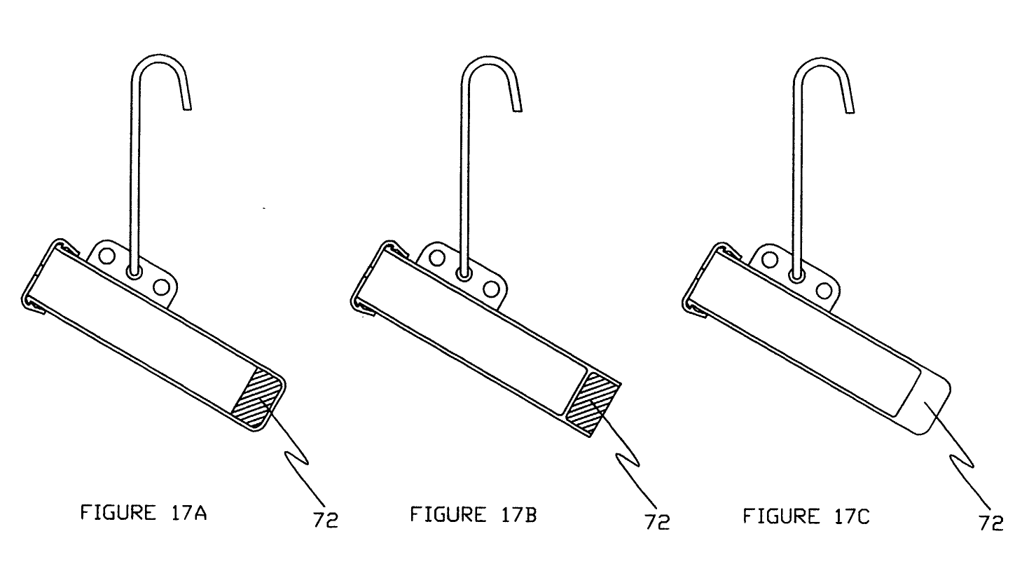

FIGS. 17a, 17b and 17c all show ways to include a counterbalance weight 72 in various versions of the preferred embodiment 17. FIGS. 17a and 17b show the counterbalance weights 72 being separate pieces that are attached near the closed end of the container 4. FIG. 17c shows the closed end of the container 4 being extra thick so that it acts as the counterbalance weight 72. Note that a counterbalance weight 72 might be especially useful when it is desirable to have a small decorative flower holder capable of displaying a heavy flower 14. By making the counterbalance weight 72 from a dense material, a large flower 14 could be effectively counterbalanced so it could be displayed at a desirable angular attitude. Note that this concept is applicable to large and small flowers 14.

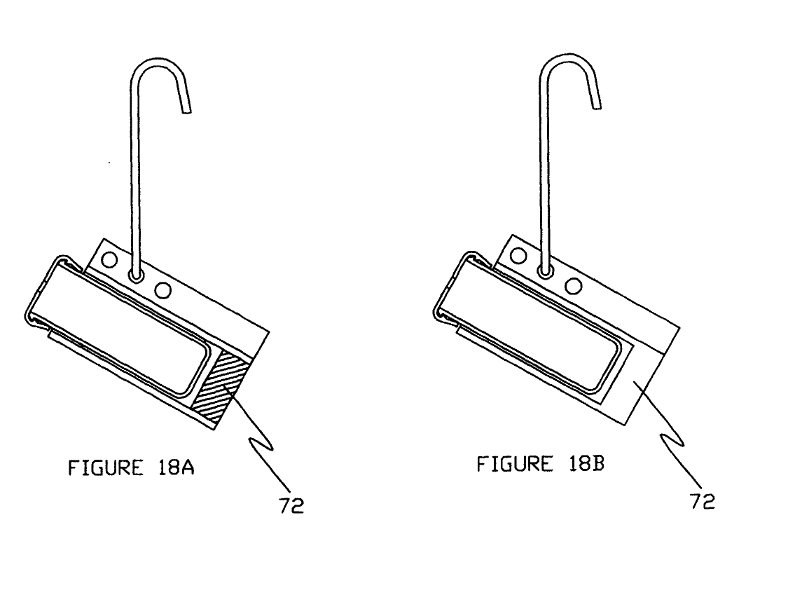

FIGS. 18a and 18b show two ways to add a counterbalance weight 72 to the second embodiment 24. In FIG. 18a the counterbalance weight 72 is a separate piece attached to the end of the hollow member 26, whereas FIG. 18b shows the counterbalance weight being an integral part of the hollow member 26.

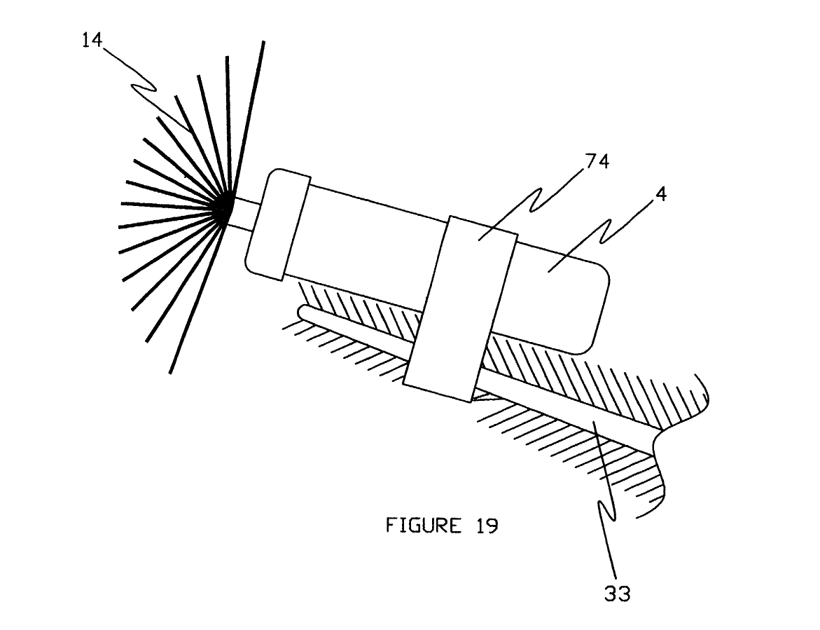

FIG. 19 shows another version of the preferred embodiment 17 similar to those shown in FIGS. 8a, 8b and 8c. In this variation, the container 4 rests directly on the Christmas Tree Branch 33 and is held in place by strap attachment 74 that wraps around said Christmas Tree Branch 33. The angular attitude of the flower 14 is controlled largely by the angular attitude of the branch itself.

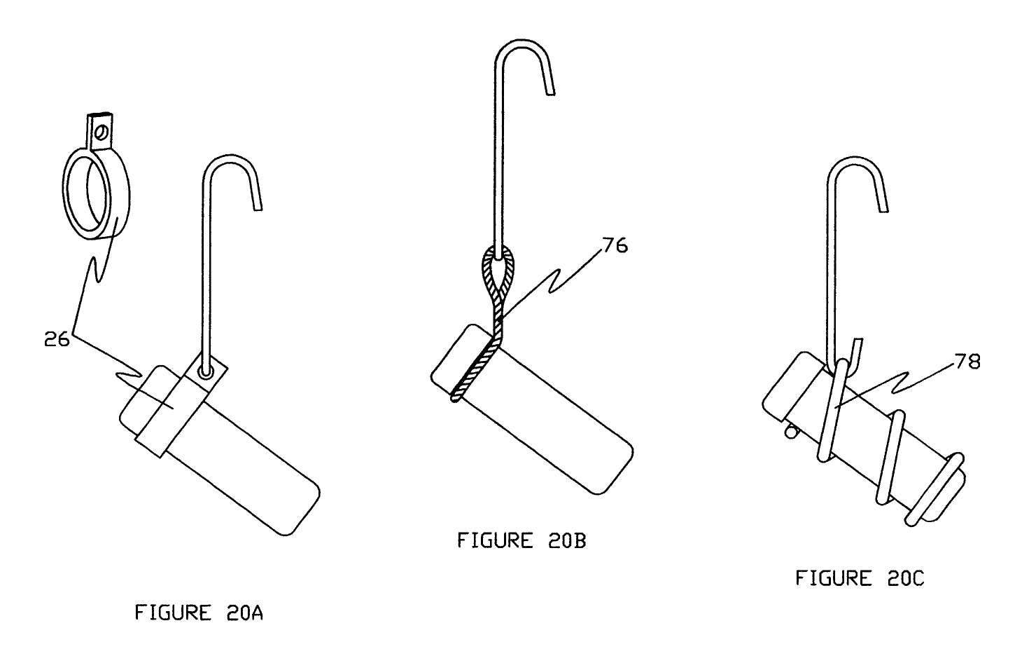

FIGS. 20a, 20b and 20c show additional variations on the second embodiment 24. FIG. 20a shows a version where the hollow member 26 is very short and includes isometric view of said short hollow member 26 also. In FIG. 20b the functions of the attachment feature 20 and tab 18 are replaced with a piece of string or wire 76. And in FIG. 20c the water vial assembly 2 is supported by a spiral member 78. This spiral member serves the functions of the tab 18, attachment feature 20 and the hollow member 26. Note that on all three variations, the counterbalancing of the flowers 14 can be adjusted by varying the length of the container 4. For the variation utilizing the spiral member 78 the attachment point of the support mechanism 22 to the spiral member can also be adjusted to optimize the counterbalance of the flower 14.

It should be understood that this invention is not limited to the detailed descriptions set forth herein which describe in detail preferred forms of the present invention. Modifications thereof will be apparent to those skilled in the art, based on the above detailed disclosure, but such modifications based on this disclosure may not be deemed to depart from the spirit and scope of the present invention as set forth in the appended claims.

What is claimed is:

1. A decorative flower holder for displaying a flower or plant material, comprising:
a container for holding fluid,
an opening in one end of said container to accommodate the insertion of said flower or plant material into said container to allow contact with said fluid,
a tab attached to said container,
an attachment feature on said tab,
said attachment feature allowing a means by which a support mechanism can attach to said tab to support the weight of said decorative flower holder and said contents of said decorative flower holder,
means to counterbalance said flower or plant material.

2. A decorative flower holder as set forth in claim 1 wherein the there is a cap over the open end of said container, said cap having a hole through which the said flower or plant material can pass.

3. A decorative flower holder as set forth in claim 1 wherein there is a hood,
said hood preventing objects near said decorative flower holder from touching flower or plant material in said decorative flower holder,

4. A decorative flower holder as set forth in claim 3 wherein said hood serves an aesthetic function.

5. A decorative flower holder as set forth in claim 1 wherein there is a receptacle in said container to receive a light bulb.

6. A decorative flower holder as set forth in claim 5 wherein said support mechanism is made up of a light bulb and the parts to which the light bulb attaches.

7. A decorative flower holder as set forth in claim 1 wherein the closed end of said container is enlarged such that a large percentage of the total fluid volume inside said container resides closer to said closed end.

8. A decorative flower holder as set forth in claim 6 wherein the weight of said fluid in said enlarged end of said container acts as said means to counterbalance said flower or plant material.

9. A decorative flower holder as set forth in claim 1 wherein said means to counterbalance said flower or plant material consists of multiple attachment features on said tab.

10. A decorative flower holder as set forth in claim 1 wherein said means to counterbalance said flower or plant material consists of varying the length of said container.

11. A decorative flower holder as set forth in claim 1 wherein the container includes a decorative motif attached to an outer surface.

12. A decorative flower holder as set forth in claim 1 wherein said means to counterbalance said flower or plant material consists of a separate weight attached to said container.

13. A decorative flower holder as set forth in claim 14 wherein said means to counterbalance said flower or plant material consists of said container built to be heavier on one side.

14. A decorative flower holder as set forth in claim 1 wherein the closed end of said container has a flat portion such that said decorative flower holder can stand vertically.

15. A decorative flower holder as set forth in claim 1 that has more than one tab.

16. A decorative flower holder as set forth in claim 15 wherein said tabs contain features that allow said decorative flower holders to connect to each other.

17. A decorative flower holder for displaying a flower or plant material, comprising:
a container for holding fluid,
an opening in one end of said container to accommodate the insertion of said flower or plant material into said container to allow contact with said fluid,
a hollow member providing means to receive, and support said container,
a tab attached to said hollow member,
an attachment feature on said tab,
said attachment feature allowing a means by which a support mechanism can attach to said tab to support the weight of said decorative flower holder and said contents of said decorative flower holder,
means to counterbalance said flower or plant material.

18. A decorative flower holder as set forth in claim 17 wherein the there is a cap over the open end of said container, said cap having a hole through which the said flower or plant material can pass.

19. A decorative flower holder as set forth in claim 17 wherein there is a hood, said hood preventing objects near said decorative flower holder from touching flower or plant material in said decorative flower holder,

20. A decorative flower holder as set forth in claim 19 wherein said hood serves an aesthetic function.

21. A decorative flower holder as set forth in claim 17 wherein there is a receptacle in said container to receive a light bulb.

22. A decorative flower holder as set forth in claim 17 wherein said means to counterbalance said flower or plant material consists of multiple attachment features on said tab on said hollow member.

23. A decorative flower holder as set forth in claim 17 wherein said means to counterbalance said flower or plant material consists of using different container lengths.

24. A decorative flower holder as set forth in claim 17 wherein said means to counterbalance said flower or plant material consists of a separate weight attached to said hollow member.

25. A decorative flower holder as set forth in claim 17 wherein said means to counterbalance said flower or plant material consists of said hollow member built to be heavier on one side.

26. A decorative flower holder as set forth in claim 17 that has more than one tab.

27. A decorative flower holder as set forth in claim 26 wherein said tabs on said hollow members contain features that allow said decorative flower holders to connect to each other.

28. A decorative flower holder as set forth in claim 17 wherein said hollow member is generally spherical in overall shape.

29. A decorative flower holder as set forth in claim 17 wherein said hollow member is replaced with a string or wire.

30. A decorative flower holder as set forth in claim 17 wherein the function of said hollow member is performed by a spirally shaped member.
